(19) United States
(12) Patent Application Publication
(10) Pub. No.: US 2009/0180423 A1
(43) Pub. Date: Jul. 16, 2009

(54) Transmission of Ethernet Packets Via CPRI Interface

(75) Inventor: Hans Kroener, Geislingen-Weiler (DE)

Correspondence Address: STAAS & HALSEY LLP, SUITE 700, 1201 NEW YORK AVENUE, N.W., WASHINGTON, DC, 20005, US

(73) Assignee: Nokia Siemens Networks GmbH & Co. KG, Munich (DE)

(21) Appl. No.: 11/988,743

(22) PCT Filed: Jun. 21, 2006
(86) PCT No.: PCT/EP2006/063424

§ 371 Date: Feb. 17, 2009

(30) Foreign Application Priority Data
Jul. 13, 2005 (EP) 05015256.0

(51) Int. Cl. H04W 40/00

(52) U.S. Cl. 370/328

(57) ABSTRACT

In a method for operating a base station having a first unit and at least one second unit, data is transferred between the first unit and the second unit via a common public radio interface. Accordingly, common public radio interface (CPRI) data is transferred as Ethernet packets. The base station used in this method may include an Ethernet switch connecting the first unit and the at least one second unit.

### CROSS REFERENCE TO RELATED APPLICATIONS

This application is based on and hereby claims priority to European Application No. 05105256 filed on Jul. 13, 2005, the contents of which are hereby incorporated by reference.

### BACKGROUND

Described below are a method for operating a base station, in which the base station has a CPRI interface between a first unit and a second unit, and a base station for carrying out the method.

In radio communication systems, messages, for example containing voice information, image information, video information, SMS (Short Message Service), MMS (Multimedia Messaging Service) or other data, are transmitted between a sending station and a receiving station via a radio interface using electromagnetic waves. Depending on the specific refinement of the radio communication system, these stations may be different kinds of subscriber radio stations or network base stations. In a mobile radio communication system, at least some of the subscriber radio stations are mobile radio stations. The electromagnetic waves are emitted at carrier frequencies which are in the frequency band provided for the respective system.

Mobile radio communication systems are often in the form of cellular systems, e.g. based on the GSM (Global System for Mobile Communication) or UMTS (Universal Mobile Telecommunications System) standard, with a network infrastructure including, by way of example, base stations, devices for inspection and control of the base stations and other network devices. Apart from these expansively organized (supralocal) cellular, hierarchic radio networks, there are also wireless local area networks (WLANs) with a radio coverage area whose expanse is usually much more severely limited. Examples of different standards for WLANs are HiperLAN, DECT, IEEE 802.11, Bluetooth and WATM.

Base stations for radio communication systems contain various units which are connected to one another by suitable interfaces. Base stations usually include units for baseband processing, with data for or from subscriber stations being processed in the devices for baseband processing. In addition, there are transmission and reception units which modulate baseband data delivered by the baseband processing onto carrier frequencies and send them to subscriber stations or convert data received from subscriber stations on the carrier frequencies to baseband and forward them to baseband processing. By way of example, the connection between a unit for baseband processing and a transmission and reception unit can be set up via an interface based on the CPRI standard (at present: CPRI Specification V2.0 (2004-10-01), Common Public Radio Interface (CPRI); Interface Specification, available at www.cpri.info/).

### SUMMARY

An aspect is to demonstrate an efficient method for operating a base station and to demonstrate exactly such a base station which involves the use of a CPRI interface.

The method described below for operating a base station involves data being transmitted between a first unit and a second unit in the base station via a CPRI interface. In line with the invention, CPRI data are transmitted as Ethernet packets.

There is a CPRI interface between the two units in the base station. Hence, the protocol stack of the two units contains layers which process data based on the CPRI standard. The CPRI data are packetized and transmitted in packets, the Ethernet standard being used for the transmission in packets. Hence, information bits are transmitted between the first and second units not continuously but rather in packets, and transmission breaks may exist between the individual packets. The fact that Ethernet packets contain CPRI data means that both the first and the second unit process the CPRI data completely on the basis of the Ethernet protocol, i.e. on the basis of the IEEE 802.3 standard. In particular, not just portions of this standard are used.

In one development, the first unit and the second unit use the Ethernet protocol for processing the CPRI data on the bottommost protocol layer. In this context, the protocol layers are the protocol layers in the ISO/OSI layer model. On layers situated above the Ethernet layer, the first unit and the second unit process the data on the basis of the CPRI stipulations.

In line with one advantageous refinement, a line code added to the CPRI data at the transmitter end corresponds exclusively to the line code based on the Ethernet protocol. In this context, the transmitter may be the first or the second unit. In this case, the CPRI data have no line code bits added to them other than those which are used on the basis of the standard for transmitting Ethernet packets.

In line with another refinement, the CPRI data contain exclusively manufacturer-independent information. This refinement precludes the transmission of manufacturer-dependent information when CPRI data are transmitted as Ethernet packets.

It is advantageous if the CPRI data contain no bits reserved for future expansions. Such bits increase the data rate, and it is therefore possible to dispense with them in order to reduce the data rate. The Ethernet packets therefore contain exclusively bits which are currently used for conveying information.

In one development, the antenna signals which the CPRI data contain have exclusively received antenna signals or antenna signals which are to be sent transmitted for them. Received antenna signals are signals which have been received by an antenna on the base station and then need to be transmitted between the first and the second unit in the base station. Antenna signals to be sent are signals which are transmitted between the first and the second unit in the base station and then need to be emitted by an antenna on the base station. In line with the development under consideration, only antenna signals which are used are transmitted via the CPRI interface. Filler bits for currently unused antenna signals are not transmitted. This results in a reduction in the data rate in comparison with the situation in which a particular number of antenna signals is transmitted via the CPRI interface, only a portion of which contains information to be emitted or received information, however.

In line with one advantageous refinement, the CPRI data are transmitted between the first unit and a plurality of second units, the first unit being connected to an Ethernet switch and the Ethernet switch being connected to the plurality of second units in a star shape. In this case, the first unit may be connected to the Ethernet switch by an Ethernet line using an electrical or optical transmission method, such as by a Gbit or 100 Gbit Ethernet line, and each of the second units may be connected to the Ethernet switch by an Ethernet line using an electrical transmission method, such as by an Mbit or 100 Mbit Ethernet line. This configuration is particularly suitable for applications in buildings in which Mbit Ethernet lines have already been laid which can be used by the base station. In addition, the first unit may be connected to the Ethernet switch by an Ethernet line using an optical transmission method, such as by a Gbit or 100 Gbit Ethernet line, and each of the second units may be connected to the Ethernet switch by an Ethernet line using an electrical transmission method, such as by a Gbit or 100 Gbit Ethernet line. This configuration is particularly suitable for spanning large distances between the two units in the base station, on account of the use of the optical transmission method.

In one refinement, the first unit and/or at least one of the second units are connected to the Ethernet switch by a plurality of Ethernet lines, with the Link Aggregation method being applied for the transmission via the plurality of Ethernet lines.

It is particularly advantageous if the Ethernet packets are transmitted between the first unit and the second unit via one or more Ethernet lines, these Ethernet lines also being used for transmitting other data. In this case, Ethernet lines are used not exclusively for the CPRI interface, but rather CPRI data can share the transmission medium with packets from other applications. In this regard, it is advantageous if the CPRI interface's Ethernet packets are transmitted using VLAN (Virtual Local Area Network) technology.

The base station has first and second units between which data are transmitted via a CPRI interface as Ethernet packets.

### BRIEF DESCRIPTION OF THE DRAWINGS

These and other aspects and advantages will become more apparent and more readily appreciated from the following description of an exemplary embodiment, taken in conjunction with the accompanying drawings of which:

FIG. 1 is a block diagram of a base station system based on the related art,

FIG. 2 is a block diagram of a first base station system,

FIG. 3A is a block diagram of a second base station system for indoor applications,

FIG. 3B is a block diagram of a third base station system for metro applications.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

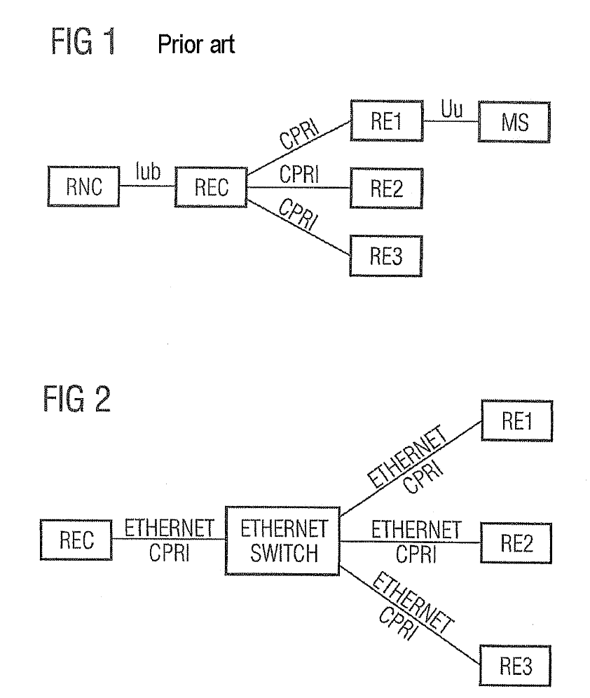

The base station system shown in FIG. 1 includes a baseband processing device REC (Radio Equipment Controller) which is connected to a radio network control device RNC (Radio Network Controller) via the interface called lub in UMTS. The baseband processing device REC is connected to the transmission and reception units RE1, RE2 and RE3 (RE: Radio Equipment) via a respective CPRI interface CPRI. The transmission and reception units RE1, RE2 and RE3 emit subscriber station data to subscriber stations and receive such data from them. FIG. 1 shows, by way of example, the subscriber station MS which is connected to the transmission and reception unit RE1 via the radio interface called Uu in UMTS. Each transmission and reception unit RE1, RE2 and RE3 is responsible for emitting radio signals on a radio frequency or in a frequency band and/or to a sector.

The CPRI interface is described in the currently valid standard version CPRI Specification V2.0, whose content is referred to here and which is part of the disclosure of the application. The CPRI interface uses an electrical and/or optical transmission method on the physical layer. The CPRI interface is used to transmit various data types, namely synchronization information, control information and useful data, using a time-division multiplex method. The CPRI standard defines layers 1 and 2 of the ISO/OSI protocol stack of the CPRI interface. In line with the related art, the information transmitted via the CPRI interface is a continuous synchronous data stream which includes the time-division multiplexed data types.

The CPRI data, i.e. the information transmitted between the baseband processing device REC and the transmission and reception units RE1, RE2 and RE3 via the CPRI interface CPRI, are transmitted as Ethernet packets. As FIG. 2 shows, this is done by virtue of the baseband processing device REC being connected to an Ethernet switch ETHERNET SWITCH which is connected to the transmission and reception units RE1, RE2 and RE3. This means that the Ethernet protocol ETHERNET is used for the CPRI data on the bottommost layer of the ISO/OSI protocol stack. In contrast to the related art, a continuous synchronous data stream is not transmitted via the CPRI interface, but rather Ethernet packets. Above the Ethernet layer there are layers specified on the basis of CPRI for processing the CPRI data.

In line with the current CPRI standard, the physical layer permits data rates of 614.4 Mbit/s, 1228.8 Mbit/s or 2457.6 Mbit/s. For transmission via Ethernet lines, data rates of 10 Mbit/s, 100 Mbit/s, 1 Gbit/s or 10 Gbit/s are possible. It would therefore be necessary to use a 1 Gbit/s Ethernet line for the 614.4 Mbit/s CPRI connection, two 1 Gbit/s Ethernet lines for the 1228.8 Mbit/s CPRI connection and three 1 Gbit/s lines for the 2457.6 Mbit/s CPRI connection. To reduce the number or bandwidth of the Ethernet lines required for transmitting CPRI data, and hence to be able to transmit the CPRI data efficiently as Ethernet packets, the following modifications are possible:
Removal of the line code:

For the CPRI line code, 8 respective bits are complemented by two bits of redundancy on the physical layer. If this line code is dispensed with, this reduces the CPRI data rate to 491.520 Mbit/s, 983.040 Mbit/s or 1966.080 Mbit/s. The use of the Ethernet protocol on the physical layer adds a line code, which means that the CPRI data are transmitted in line-encoded form despite the disappearance of the CPRI line code.

In line with the related art, during the CPRI transmission, the receiver can identify from the line code what components of the CPRI data can be found at what location within the continuous CPRI data stream. If the CPRI line code is dispensed with, an association should be provided between the structure of the CPRI data and the Ethernet packets which contain the CPRI data. By way of example, the Ethernet packets can have information fields added to them which indicate the start and end of the CPRI frame and the CPRI hyperframe.
Removal of the manufacturer-specific information and/or of the bits reserved for future expansions:

The removal of the manufacturer-specific control information from the CPRI data results in a reduction in the CPRI data rate by

$$\frac{16}{16 \cdot 256} = 0.0039 or \frac{192}{16 \cdot 256} = 0.047 ,$$

depending on the use of the pointer.

The removal of the bits reserved for future expansions from the CPRI data results in a reduction in the CPRI data rate by

$$\frac{52}{16 \cdot 256} = 0.013 .$$

Removal of unused antenna signals:

Depending on the form of the base station, a different number of antenna signals is required, an antenna signal being understood to mean the signal emitted or received by an antenna. Usually, a UMTS base station has six antennas, whereas a micro base station has just one antenna. The different number of antennas used means that it is possible that transmission resources which are provided and reserved for antenna signals are not used in the case of CPRI. For unused antenna signals, zeros are transmitted between the baseband processing device REC and the transmission and reception units RE1, RE2 and RE3. Removing these unused resources from the CPRI data reduces the bandwidth required for transmitting CPRI data further.

Using the measures explained, it is possible to transmit a connection for CPRI data, which originally requires 1228.8 Mbit/s, via 1 Gbit/s Ethernet line, a 2457.6 Mbit/s CPRI connection via two 1 Gbit/s Ethernet lines and a 614.4 Mbit/s CPRI connection via a few 100 Mbit/s Ethernet lines.

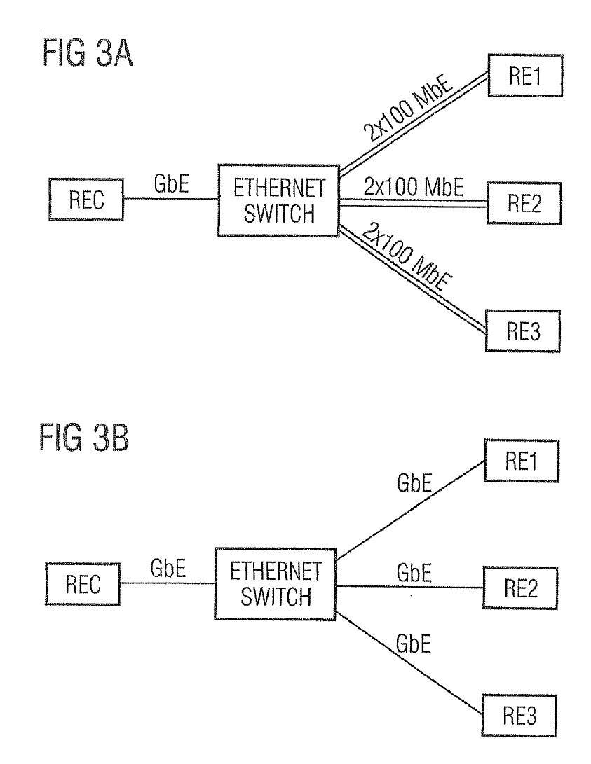

If the CPRI data are transmitted using Ethernet packets, existing Ethernet lines can be used to connect the baseband processing device REC to the transmission and reception units RE1, RE2 and RE3. FIGS. 3A and 3B show examples of the use of existing Ethernet lines for the connection between the baseband processing device REC and the transmission and reception units RE1, RE2 and RE3.

The configuration shown in FIG. 3A is particularly suitable for indoor applications, i.e. for cases in which the transmission and reception units RE1, RE2 and RE3 are inside a building. The baseband processing device REC is connected to the Ethernet switch ETHERNET SWITCH by a gigabit Ethernet line GbE, whereas the transmission and reception units RE1, RE2 and RE3 are respectively connected to the Ethernet switch ETHERNET SWITCH by two 100 Mbit Ethernet lines 100 MbE. It is naturally possible for the transmission and reception units RE1, RE2 and RE3 to be respectively connected to the Ethernet switch ETHERNET SWITCH by different numbers of Ethernet lines. An indoor base station usually provides coverage for just one radio cell, a radio cell being understood to mean a particular sector in combination with a particular frequency band. An indoor base station therefore has no requirement for high data rates to be transmitted from and to the transmission and reception units RE1, RE2 and RE3, which means that the two 100 Mbit Ethernet lines 100 MbE are sufficient to supply one transmission and reception unit RE1, RE2 or RE3 each. In the case of 100 Mbit Ethernet lines, an electrical transmission method is used, and the range of these connections is several 100 meters at most. Many buildings are wired with 100 Mbit Ethernet lines, which means that already existing lines can be used for transmitting the CPRI data.

The configuration shown in FIG. 3B is particularly suitable for metro applications, i.e. for instances in which the transmission and reception units RE1, RE2 and RE3 are distributed within an area which is approximately the size of a town. The baseband processing device REC is connected to the Ethernet switch ETHERNET SWITCH by a gigabit Ethernet line GbE, and the transmission and reception units RE1, RE2 and RE3 are also respectively connected to the Ethernet switch ETHERNET SWITCH by a gigabit Ethernet line GbE. For radio coverage in an urban area, the transmission and reception units RE1, RE2 and RE3 need to cover a larger geographical area in comparison with the indoor scenario, and in this case a base station usually provides coverage for a plurality of radio cells. A larger volume of information is therefore sent to and received from subscriber stations by the transmission and reception units RE1, RE2 and RE3 than in the case of the indoor scenario, which means that it is appropriate to connect the transmission and reception units RE1, RE2 and RE3 by gigabit Ethernet lines GbE. For the gigabit Ethernet lines GbE, an optical transmission method is used, which means that the gigabit Ethernet lines can extend over several kilometers. Instead of the gigabit Ethernet lines GbE, it is also possible to use 10 gigabit Ethernet lines. Transmitting CPRI data over gigabit Ethernet lines is advantageous because these connections are not expensive and are increasingly being laid.

It is advantageous if the Ethernet lines are used to transport not exclusively CPRI data but also other data. The Ethernet lines' transmission resources can therefore be split between the CPRI application and other applications. Since the CPRI data need to be transmitted in real time, it is advantageous to use the VLAN (Virtual Local Area Network) technology known from Ethernet. This allows the CPRI data to be allocated a higher priority than the data of the other applications. VLAN is described by way of example in IEEE: Carrier sense multiple access with collision detection (CSMA/CD) access method and physical layer specification, IEEE Standards IEEE 802.3, 2002, part 1, particularly pages 42 and 43, and 802.1Q, IEEE Standards for Local and metropolitan area networks, Virtual Bridged Local Area Networks, May 7, 2003.

If a plurality of parallel Ethernet lines are being used, as in FIG. 3A between the Ethernet switch ETHERNET SWITCH and the transmission and reception units RE1, RE2 and RE3, for example, it is appropriate to use the Link Aggregation Method known from Ethernet, described by way of example in IEEE: Carrier sense multiple access with collision detection (CSMA/CD) access method and physical layer specification, IEEE Standards IEEE 802.3, 2002, part 2, particularly pages 269 ff. In this context, data are alternately passed to the plurality of lines.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network. A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-13. (canceled)

14. A method for operating a base station that has a first unit and a second unit, comprising:
transmitting common public radio interface data as Ethernet packets via a common public radio interface between the first unit and the second unit.

15. The method as claimed in claim 1, further comprising processing the common public radio interface data in the first and second units using a bottommost protocol layer of an Ethernet protocol.

16. The method as claimed in claim 15, further comprising adding a line code to the common public radio interface data, solely based on the Ethernet protocol, prior to said transmitting.

17. The method as claimed in claim 16, wherein the common public radio interface data contain exclusively manufacturer-independent information.

18. The method as claimed in claim 17, wherein the common public radio interface data contain no bits reserved for future expansion.

19. The method as claimed in claim 18, wherein the common public radio interface data contain antenna signals including only received antenna signals or antenna signals to be transmitted.

20. The method as claimed in claim 19, wherein the first unit is connected to an Ethernet switch and the Ethernet switch is connected to a plurality of second units in a star shape, and
wherein said transmitting transmits the common public radio interface data between the first unit and the plurality of second units.

21. The method as claimed in claim 20, wherein the first unit is connected to the Ethernet switch by an Ethernet line using an electrical or optical transmission medium, and each of the second units is connected to the Ethernet switch by an Ethernet line using a corresponding electrical transmission medium.

22. The method as claimed in claim 20, wherein the first unit is connected to the Ethernet switch by an Ethernet line using a first optical transmission medium, and each of the second units is connected to the Ethernet switch by an Ethernet line using a corresponding second optical transmission medium.

23. The method as claimed in claim 22, wherein at least one of the first and second units is connected to the Ethernet switch by Ethernet lines, and
wherein said transmitting comprises applying a Link Aggregation method via the plurality of Ethernet lines.

24. The method as claimed in claim 23, wherein said transmitting transmits the Ethernet packets between the first unit and the second unit via at least one of the Ethernet lines, each of which is also used for transmitting other data.

25. The method as claimed in claim 24, wherein said transmitting of the Ethernet packets uses a virtual local area network.

26. A base station having a first unit and a second unit between which data are transmitted via a common public radio interface, comprising:
means for transmitting common public radio interface data as Ethernet packets.
